(19) United States
(12) Patent Application Publication
(10) Pub. No.: US 2026/0188189 A1
(43) Pub. Date: Jul. 2, 2026

(54) DISPLAY DEVICE AND ELECTRONIC DEVICE INCLUDING THE SAME

(71) Applicant: Samsung Display Co., LTD., Yongin-si (KR)

(72) Inventors: Jaesang Kim, Yongin-si (KR); SEONGJOO LEE, Yongin-si (KR); OHJO KWON, Yongin-si (KR)

(21) Appl. No.: 19/330,227

(22) Filed: Sep. 16, 2025

(30) Foreign Application Priority Data
Dec. 31, 2024 (KR) 10-2024-0202035

(51) Int. Cl. G09G 3/32; G09G 3/3266; G09G 3/3291

(52) U.S. Cl. CPC G09G 3/32; G09G 3/3266; G09G 3/3291; G09G 2300/0814; G09G 2300/0857; G09G 2310/0267; G09G 2310/0275; G09G 2310/0289; G09G 2310/08; G09G 2330/021

(57) ABSTRACT

A display device includes a display panel, a gate driver, a data driver and a driving controller which controls the gate driver and the data driver. The gate driver include a plurality of gate signal generators. A gate signal generator of the gate signal generators includes a first flip-flop which receives a clock signal and outputs a logic signal by sampling a previous carry signal at a rising edge of the clock signal, a first invertor which receives the clock signal and outputs an inverted clock signal having inverted waveform of the clock signal, a second flip-flop which output a carry signal by sampling the logic signal at a rising edge of the inverted clock signal. The gate driver outputs the gate signal based on the logic signal.

This application claims priority to Korean Patent Application No. 10-2024-0202035, filed on December 31, 2024, and all the benefits accruing therefrom under 35 U.S.C. §119, the content of which in its entirety is herein incorporated by reference.

### BACKGROUND

### Field

Embodiments of the invention relate to a display device. More particularly, embodiments of the invention relate to a display device and an electronic device including the display device.

### Description of the Related Art

Generally, a display device includes a display panel and a display panel driver. The display panel includes a plurality of gate lines, a plurality of data lines, a plurality of emission lines and a plurality of pixels. The display panel driver includes a gate driver for providing a gate signal to the gate lines, a data driver for providing a data voltage to the data lines, an emission driver for providing an emission signal to the emission lines and a driving controller for controlling the gate driver, the data driver and the emission driver.

Generally, for improving a driving reliability of the gate driver, a hold margin of a carry signal may be desired to be improved.

### SUMMARY

Embodiments of the invention provide a display device improving a display quality by improving a hold margin of a carry signal.

Embodiments of the invention provide an electronic device including the display device.

According to embodiments, a display device includes a display panel including a pixel, a gate driver which outputs a gate signal to the display panel, a data driver which applies a data voltage to the display panel and a driving controller which controls the gate driver and the data driver. In such embodiments, the gate driver includes a plurality of gate signal generators. In such embodiments, a gate signal generator of the gate signal generators includes a first flip-flop which receive a clock signal and outputs a logic signal by sampling a previous carry signal at a rising edge of the clock signal, a first invertor which receives the clock signal and outputs an inverted clock signal having inverted waveform of the clock signal, a second flip-flop which outputs a carry signal by sampling the logic signal at a rising edge of the inverted clock signal. In such embodiments, the gate driver outputs the gate signal based on the logic signal.

In an embodiment, a period in which the gate driver is driven may include first to sixth periods. In such an embodiment, in the first period, the previous carry signal may have a logic high level, the clock signal may have a logic low level, the inverted clock signal may have a logic high level, the carry signal may have a logic low level, and the logic signal may have a logic low level.

In an embodiment, in the second period following the first period, the previous carry signal may have the logic high level, the clock signal may have a logic high level, the inverted clock signal may have a logic low level, the carry signal may have the logic low level, and the logic signal may have a logic high level.

In an embodiment, in the third period following the second period, the previous carry signal may have a logic low level, the clock signal may have the logic low level, the inverted clock signal may have the high low level, the carry signal may have a logic high level, and the logic signal may have the logic high level.

In an embodiment, in the fourth period following the third period, the previous carry signal may have the logic low level, the clock signal may have the logic high level, the inverted clock signal may have the logic low level, the carry signal may have the logic high level, and the logic signal may have the logic low level.

In an embodiment, in the fifth period following the fourth period, the previous carry signal may have the logic low level, the clock signal may have the logic low level, the inverted clock signal may have the logic high level, the carry signal may have the logic low level, and the logic signal may have the logic low level.

In an embodiment, in the sixth period following the fifth period, the previous carry signal may have the logic low level, the clock signal may have the logic high level, the inverted clock signal may have the logic low level, the carry signal may have the logic low level, and the logic signal may have the logic low level.

In an embodiment, the first flip-flop may include an input terminal which receives the previous carry signal, clock terminal which receives the clock signal and an output terminal which outputs the logic signal. In such an embodiment, the first invertor may include an input terminal which receives the clock signal and an output terminal which outputs the inverted clock signal. In such an embodiment, the second flip-flop may include an input terminal which receives the logic signal, a clock terminal which receives the inverted clock signal and an output terminal which outputs the carry signal.

In an embodiment, the gate signal generator may further include a level shifting block which outputs a first logic signal by changing a voltage level of the logic signal and an outputting block which outputs the gate signal based on the first logic signal.

In an embodiment, the outputting block may include an AND gate which outputs a second logic signal by performing an AND calculation between the first logic signal and the carry signal and a NAND gate which outputs the gate signal by performing a NAND calculation between the second logic signal and a masking signal.

In an embodiment, the gate driver may include first to K-th gate signal generators which are sequentially located in a first direction and a clock signal outputting block which outputs the clock signal, where K is an integer greater than 1. In such an embodiment, the clock signal outputting block may include a first buffer block which outputs the clock signal and a second buffer block which outputs the clock signal to each of the first to K-th gate signal generators. In such an embodiment, the first buffer block may have a cascade structure of a plurality of first clock buffers.

In an embodiment, the first buffer block may include a first buffer group in which the first clock buffers are sequentially arranged in the first direction and a second buffer group in which the first clock buffers are sequentially arranged in a second direction opposite to the first direction. In such an embodiment, the second buffer block may include multiplexers which selectively connect a corresponding one of the first buffer group and the second buffer group to each of the first to K-th gate signal generator.

In an embodiment, the second buffer block may further include second clock buffers connected between the first buffer block and the multiplexer. In such an embodiment, A size of the first clock buffer may be larger than a size of the second clock buffer.

In an embodiment, the first clock buffer may include sixteen clock buffers, and the second clock buffer includes one clock buffer. In such an embodiment, the clock buffer may have a structure in which two invertors are connected in series.

In an embodiment, the clock buffer may include a first transistor including a control electrode connected to a first node, a first electrode which receives a high voltage and a second electrode connected to a second node, a second transistor including a control electrode connected to the second node, a first electrode which receives the high voltage and a second electrode connected to a third node, a third transistor including a control electrode connected to the first node, a first electrode which receives a low voltage lower than the high voltage and a second electrode connected to the second node and a fourth transistor including a control electrode connected to the second node, a first electrode which receives the low voltage and a second electrode connected to the third node.

According to embodiments, an electronic device includes a display panel including a pixel, a gate driver which outputs a gate signal to the display panel, a data driver which applies a data voltage to the display panel, a driving controller which controls the gate driver and the data driver based on an input control signal and a processor which outputs the input control signal. In such embodiments, the gate driver includes a plurality of gate signal generators. In such embodiments, a gate signal generator of the gate signal generators includes a first flip-flop which receives a clock signal and outputs a logic signal by sampling a previous carry signal at a rising edge of the clock signal, a first invertor which receives the clock signal and outputs an inverted clock signal having inverted waveform of the clock signal, a second flip-flop which outputs a carry signal by sampling the logic signal at a rising edge of the inverted clock signal. In such embodiments, The gate driver outputs the gate signal based on the logic signal.

In an embodiment, the first flip-flop may include an input terminal which receives the previous carry signal, clock terminal which receives the clock signal and an output terminal which outputs the logic signal. The first invertor may include an input terminal which receives the clock signal and an output terminal which outputs the inverted clock signal. In such an embodiment, The second flip-flop may include an input terminal which receives the logic signal, a clock terminal which receives the inverted clock signal and an output terminal which outputs the carry signal.

In an embodiment, the gate signal generator may further include a level shifting block which outputs a first logic signal by changing a voltage level of the logic signal and an outputting block which outputs the gate signal based on the first logic signal.

In an embodiment, the outputting block may include: an AND gate which outputs a second logic signal by performing an AND calculation between the first logic signal and the carry signal and a NAND gate which outputs the gate signal by performing a NAND calculation between the second logic signal and a masking signal.

In an embodiment, the gate driver may include first to K-th gate signal generators which are sequentially arranged in a first direction and a clock signal outputting block which outputs the clock signal, where K is an integer greater than 1. In such an embodiment, the clock signal outputting block may include a first buffer block which outputs the clock signal and a second buffer block which outputs the clock signal to each of the first to K-th gate signal generators. In such an embodiment, the first buffer block may have a cascade structure of a plurality of first clock buffers.

In embodiments of the invention, as described above, the logic signal may be generated based on the clock signal and the first flip-flop, and the carry signal may be generated based on the inverted clock signal and the second flip-flop. Accordingly, a length of an activation period of the logic signal and the carry signal may be longer than a length of one pulse of the clock signal. In such embodiments, a length of a period in which the logic signal and the carry signal have a logic high level may be longer than a length of a period in which the clock signal has a logic high level, such that a hold margin of the logic signal and the carry signal may be secured. Since the hold margin of the logic signal and the carry signal may be secured, a driving reliability of the gate driver may be improved. Accordingly, a display quality of the display device may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a block diagram illustrating an example of a gate driver included in a display device.

FIG. 3 is a block diagram illustrating an example of a stage included in a gate driver of FIG. 2.

FIG. 4 is a circuit diagram illustrating an example of a logic block included in a stage of FIG. 3.

FIG. 5 is a signal timing diagram illustrating an example of signals of a logic block of FIG. 4.

FIG. 6 is a block diagram illustrating an example of a gate driver included in a display device of FIG. 1.

FIG. 7 is a block diagram illustrating an example of a gate driver included in a display device of FIG. 1.

FIG. 8 is a circuit diagram illustrating an example of a clock buffer included in a gate driver of FIG. 6.

FIG. 9 is a circuit diagram illustrating an example of a pixel included in a display device of FIG. 1.

FIG. 10 is a circuit diagram illustrating an example of an outputting block included in a stage of FIG. 3.

FIG. 11 is a signal timing diagram illustrating an example of signals of an outputting block of FIG. 10.

FIG. 12 is a diagram illustrating an example of a pixel circuit included in a display device of FIG. 1 located on a substrate.

FIG. 13 is a block diagram illustrating an electronic device according to embodiments of the invention.

FIG. 14 to FIG. 16 are schematic diagrams illustrating an electronic device according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

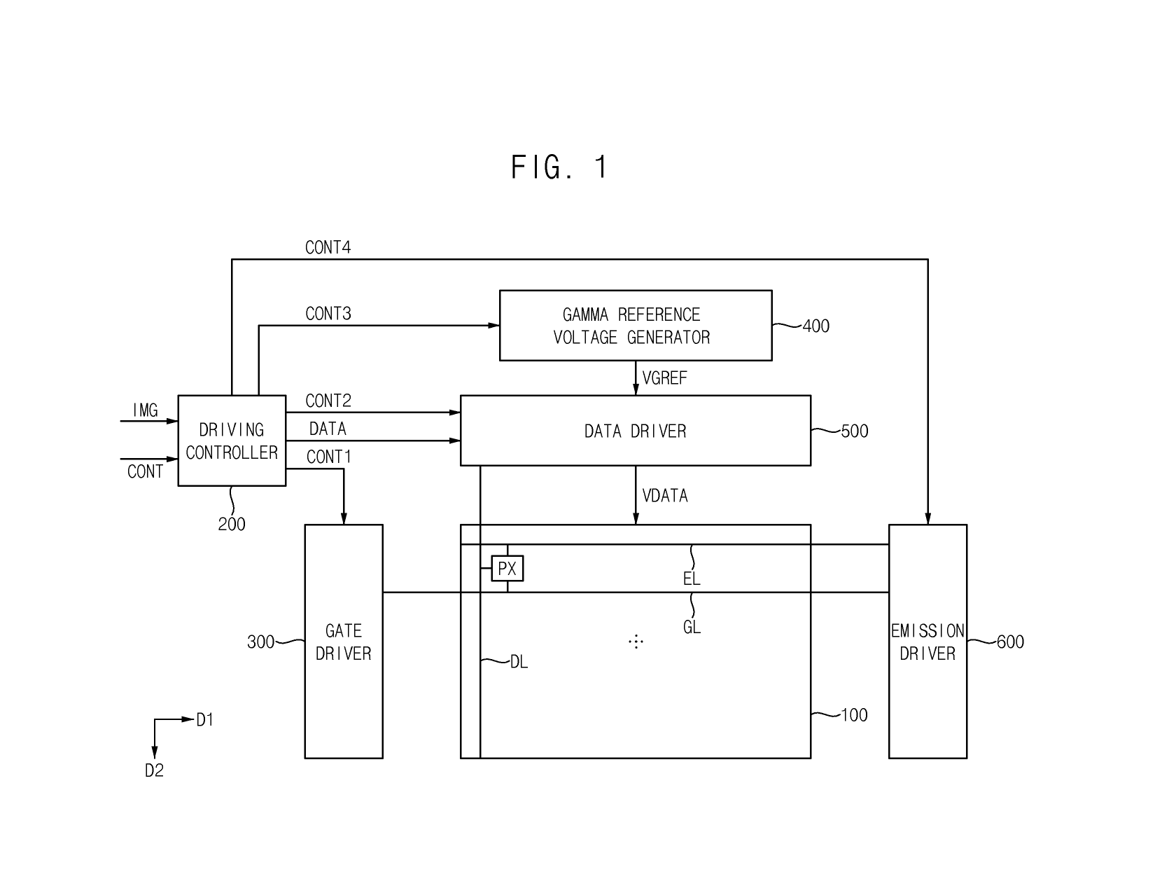

FIG. 1 is a block diagram illustrating a display device 1 according to embodiments of the invention.

Referring to FIG. 1, an embodiment of the display device 1 includes a display panel 100 and a display panel driver. The display panel driver includes a driving controller 200, a gate driver 300, a gamma reference voltage generator 400, a data driver 500 and an emission driver 600.

The display panel 100 includes a display region on which an image is displayed and a peripheral region adjacent to the display region.

The display panel 100 includes a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 receives input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals for driving the gate lines GL in response to the first control signal CONT1 received from the driving controller 200. The gate driver 300 may output the gate signals to the gate lines GL. In an embodiment, for example, the gate signals may include a first initialization gate signal GI1 of FIG. 10, a second initialization gate signal GI2 of FIG. 10, a write gate signal GW of FIG. 10, a compensation gate signal GC of FIG. 10 and a bias signal EB of FIG. 10.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed (or integrated) in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

The emission driver 600 may generate emission signal EM of FIG. 10 in response to the fourth control signal CONT4 received from the driving controller 200. The emission driver 600 may output the emission signal EM of FIG. 10 to the display panel 100.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of illustration and description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other as a single chip.

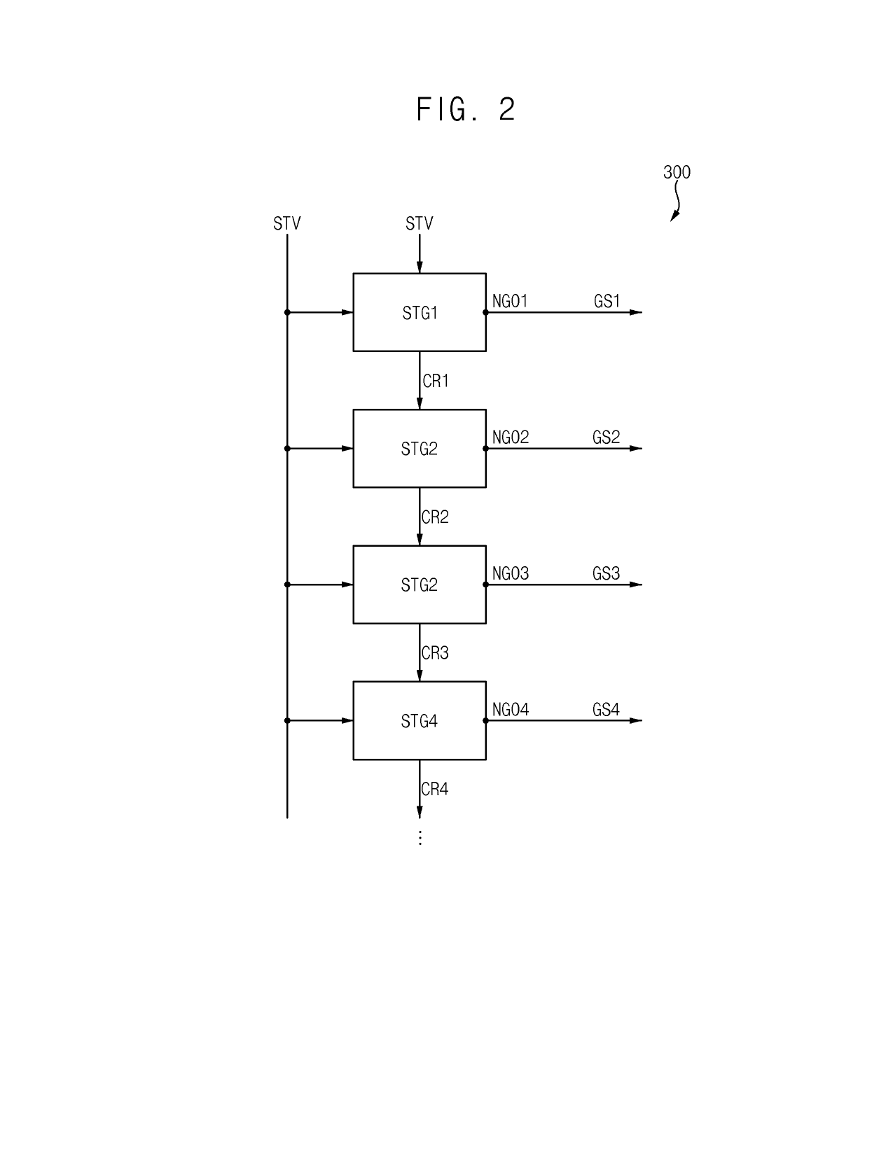

FIG. 2 is a block diagram illustrating an example of a gate driver 300 included in a display device 1.

Referring to FIG. 1 and FIG. 2, an embodiment of the gate driver 300 may include a plurality of stages STG1, STG2, STG3, STG4, …. In the disclosure, the stage may be referred to as a gate signal generator. The gate driver 300 may be implemented in the form of a shift register including a plurality of stages STG1, STG2, STG3, STG4, … that sequentially outputs gate signals GS1, GS2, GS3, GS4, …. The gate driver 300 may include N stages STG1, STG2, STG3, STG4, …. Herein, N may be a positive integer. For example, the gate driver 300 may be a scan driver or an emission driver included in a display device. For example, the gate driver 300 may be a write driver that sequentially outputs the write gate signals to the pixels PX, a compensation driver that sequentially outputs the compensation gate signal to the pixels PX, a first initialization driver that sequentially outputs the first initialization gate signal to the pixels PX, a second initialization driver that sequentially outputs the second initialization gate signal to the pixels PX, a bias driver that sequentially outputs a bias signal to the pixels PX and the emission driver 600 that sequentially outputs the emission signal to the pixels PX.

The plurality of stages STG1, STG2, STG3, STG4, … may sequentially output carry signals CR1, CR2, CR3, CR4, … and the gate signals GS1, GS2, GS3, GS4, … based on the vertical start signal STV and the clock signal CLK. Additionally, the first stage STG1 may receive the start signal STV as a carry input signal, and each of the subsequent stages STG2, STG3, STG4, … may receive a carry signal of a previous stage as a carry input signal. For example, the carry signal of the previous stage may be called as a previous carry signal.

The first stage STG1 may output the first carry output signal CR1 by shifting or delaying the vertical start signal STV by a period of the clock signal CLK.

The first stage STG1 may generate the first gate signal GS1 based on the vertical start signal STV. The first stage STG1 may generate the first carry signal CR1 based on the vertical start signal STV. The first stage STG1 may output the first gate signal GS1 at a first gate output node NGO1. The second stage STG2 may output the second carry signal CR2 based on the first carry signal CR1. The second stage STG2 may output the second gate signal GS2 at a second gate output node NGO2 based on the first carry signal CR1. The third stage STG3 may output the third carry signal CR3 based on the second carry signal CR2. The third stage STG3 may output the third gate signal GS3 at a third gate output node NGO3 based on the second carry signal CR2. The fourth stage STG4 may output the fourth carry signal CR4 based on the third carry signal CR3. The fourth stage STG4 may output the fourth gate signal GS4 at a fourth gate output node NGO4 based on the third carry signal CR3. In this manner, the plurality of stages STG1, STG2, STG3, STG4, ... may sequentially output the carry signals CR1, CR2, CR3, CR4, ... and the gate signals GS1, GS2, GS3, GS4, ....

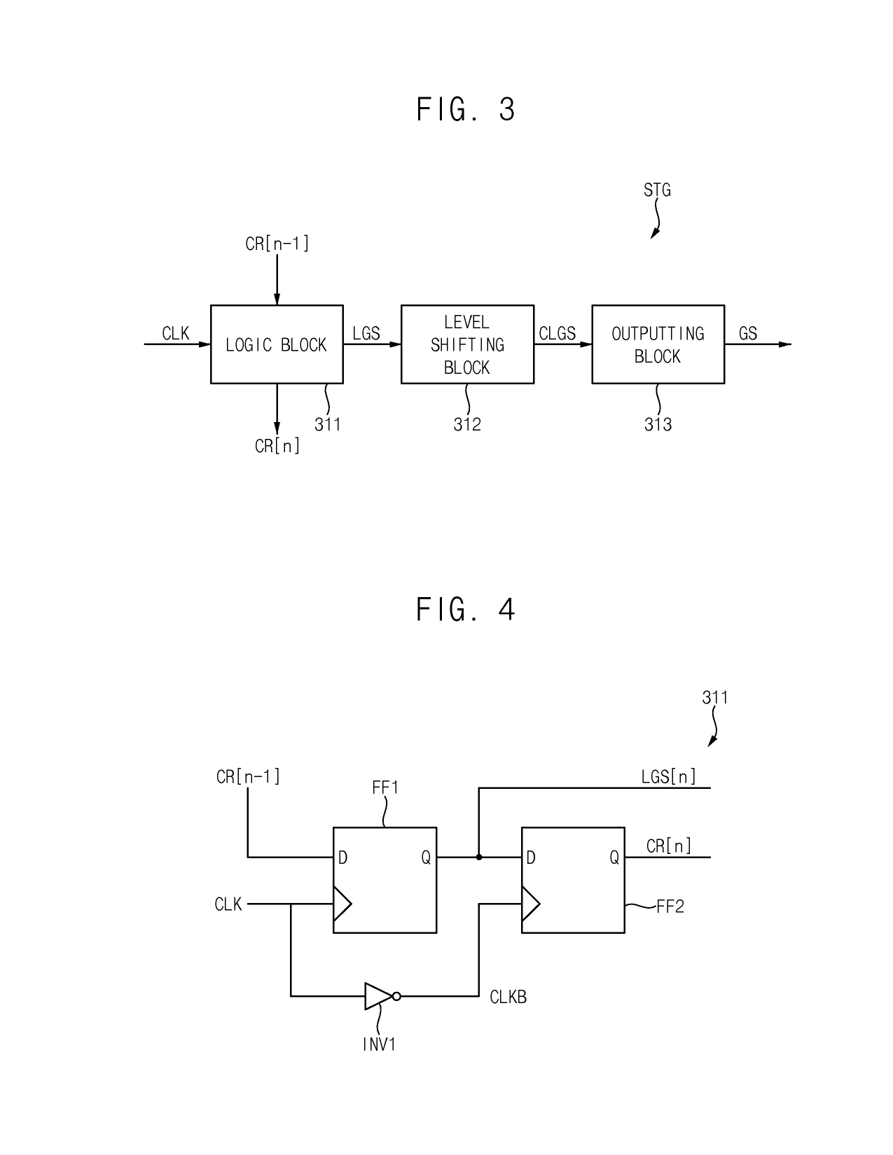

FIG. 3 is a block diagram illustrating an example of a stage STG included in a gate driver 300 of FIG. 2.

Referring to FIG. 1 to FIG. 3, an embodiment of the stage STG may include a logic block 311, a level shifting block 312 and an outputting block 313.

The logic block 311 may generate a carry signal CR[n] and a logic signal LGS based on the clock signal CLK and a previous carry signal CR[n-1]. The logic block 311 may output the logic signal LGS to the level shifting block 312.

The level shifting block 312 may generate a converted logic signal CLGS based on the logic signal LGS. The level shifting block 312 may change a voltage level of the logic signal LGS. For example, when the logic signal LGS has a high voltage level or a low voltage level, the level shifting block 312 may change a voltage level of the high voltage level of the logic signal LGS. For example, when the logic signal LGS has a high voltage level or a low voltage level, the level shifting block 312 may change a voltage level of the low voltage level of the logic signal LGS. The level shifting block 312 may output the converted logic signal CLGS to the outputting block 313.

The outputting block 313 may output the gate signal GS based on the converted logic signal CLGS. The outputting block 313 may control the output timing of the converted logic signal CLGS. The outputting block 313 may control the output timing of the converted logic signal CLGS, and output the gate signal GS based on the converted logic signal CLGS.

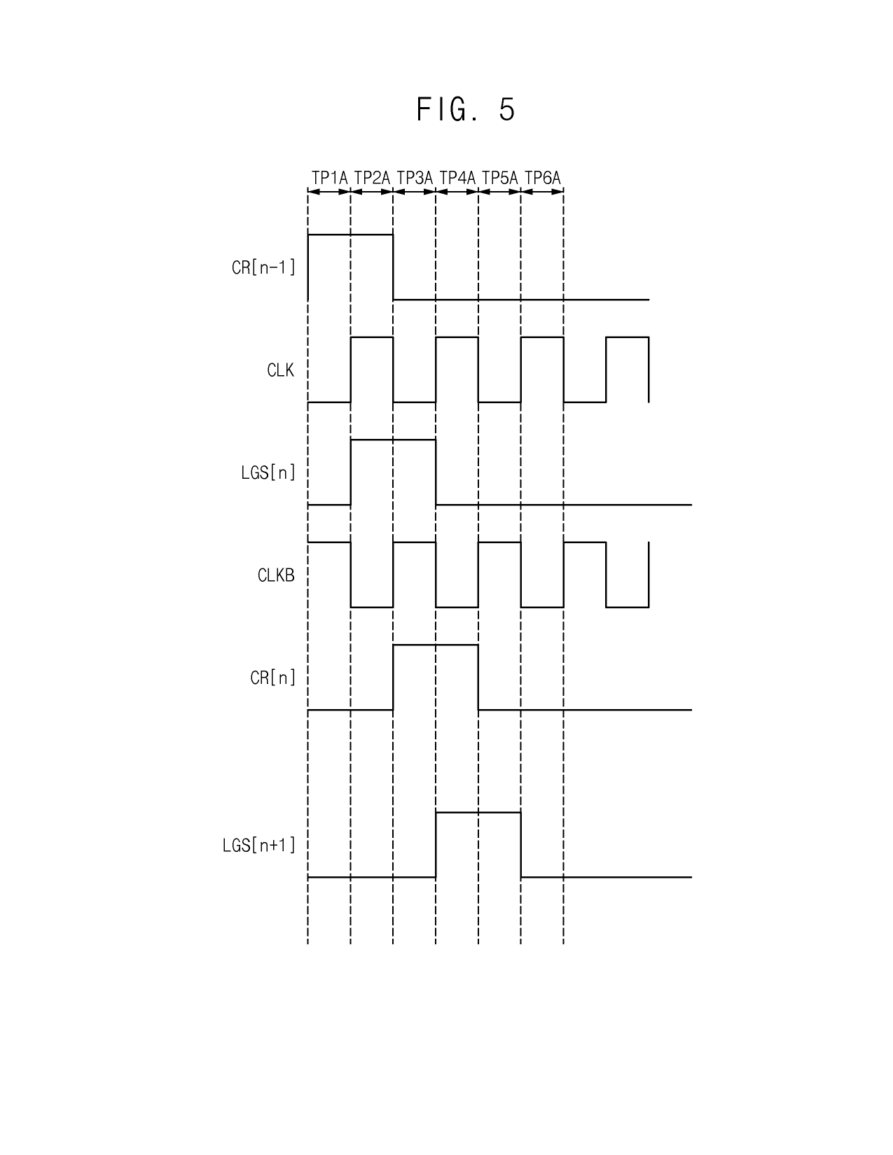

FIG. 4 is a circuit diagram illustrating an example of a logic block LGB included in a stage STG of FIG. 3. FIG. 5 is a signal timing diagram illustrating an example of signals of a logic block LGB of FIG. 4.

Referring to FIG. 1 to FIG. 5, an embodiment of the logic block 311 may include a first flip-flop FF1, invertor INV1 and a second flip-flop FF2.

The first flip-flop FF1 may include an input terminal D that receives a previous carry signal CR[n-1], a clock terminal that receives the clock signal CLK and an output terminal Q that outputs a logic signal LGS[n]. The first flip-flop FF1 may sample the previous carry signal CR[n-1] at a rising edge of the clock signal CLK to output the logic signal LGS[n].

The inverter INV1 may include an input terminal that receives the clock signal CLK and an output terminal that outputs an inverted clock signal CLKB. The inverter INV1 may invert the clock signal CLK and output the inverted clock signal CLKB. A phase of the clock signal CLK may be opposite to a phase of the inverted clock signal CLKB. Since the logic block 311 may include the inverter INV1, each of the stages may include the inverter INV1. Accordingly, a signal stability and a signal reliability of the inverted clock signal CLKB may be improved.

The second flip-flop FF2 may include an input terminal D that receives the logic signal LGS[n], a clock terminal that receives the inverted clock signal CLKB and an output terminal Q that outputs the carry signal CR[n]. The second flip-flop FF2 may sample the logic signal LGS[n] at a rising edge of the inverted clock signal CLKB and output the carry signal CR[n].

A period in which the stage STG is driven may include first to sixth periods TP1A, TP2A, TP3A, TP4A, TP5A and TP6A as shown in FIG. 5.

A voltage level of the logic high level may be higher than a voltage level of the logic low level. For example, when the voltage level of the logic high level is applied to a control electrode of the P-type transistor, the P-type transistor may be turned off. For example, when the voltage level of the logic low level is applied to a control electrode of the P-type transistor, the P-type transistor may be turned on. For example, when the voltage level of the logic high level is applied to a control electrode of the N-type transistor, the N-type transistor may be turned on. For example, when the voltage level of the logic low level is applied to a control electrode of the N-type transistor, the N-type transistor may be turned off.

In an embodiment, the carry signals and logic signals of the gate driver 300 may have phases opposite to the timing diagram of FIG. 5. For example, the previous carry signal CR[n-1] may have a logic low level in the first to second periods TP1A and TP2A, and a logic high level in the third to sixth periods TP3A, TP4A ,TP5A and TP6A. For example, the carry signal CR[n] may have a logic high level in the first to second periods TP1A and TP2A, a logic low level in the third to fourth periods TP3A and TP4A, and a logic high level in the fifth to sixth periods TP5A and TP6A. For example, the logic signal LGS[n] may have a logic high level in the first period TP1A, a logic low level in the second to third periods TP2A and TP3A, and a logic high level in the fourth to sixth periods TP4A, TP5A and TP6A.

In the first period TP1A, the previous carry signal CR[n-1] may have a logic high level, the clock signal CLK may have a logic low level, the logic signal LGS[n] may have a logic low level, the inverted clock signal CLKB may have a logic high level, the carry signal CR[n] may have a logic low level, and the next logic signal LGS[n+1] may have a logic low level. The next logic signal LGS[n+1] may mean a logic signal of the next stage.

In the first period TP1A, the clock signal CLK may have the logic low level, so that the carry signal CR[n] may not be changed. In the first period TP1A, the clock signal CLK may have the logic low level, so that the first flip-flop FF1 may not sample the carry signal CR[n]. Accordingly, in the first period TP1A, the logic signal LGS[n] may maintain the logic low level. In the first period TP1A, the inverted clock signal CLKB may be changed to the logic high level. In the first period TP1A, the second flip-flop FF2 may sample the logic signal LGS[n] based on the rising edge of the inverted clock signal CLKB. In the first period TP1A, since the logic signal LGS[n] may have the logic low level, so that the second flip-flop FF2 may output a carry signal CR[n] having the logic low level.

In the second period TP2A, the previous carry signal CR[n-1] may have the logic high level, the clock signal CLK may have a logic high level, the logic signal LGS[n] may have a logic high level, the inverted clock signal CLKB may have a logic low level, and the carry signal CR[n] may have the logic low level.

In the second period TP2A, the clock signal CLK may be changed from the logic low level to the logic high level. In the second period TP2A, the first flip-flop FF1 may sample the previous carry signal CR[n-1] based on the rising edge of the clock signal CLK. In the second period TP2A, the first flip-flop FF1 may sample the previous carry signal CR[n-1] and output a logic signal LGS[n] having the logic high level. In the second period TP2A, the inverted clock signal CLKB may have the logic low level. Accordingly, the carry signal CR[n] may have the logic low level in the second period TP2A. For example, the carry signal CR[n] may be maintained at a logic low level in the second period TP2A.

In the third period TP3A, the previous carry signal CR[n-1] may have a logic low level, the clock signal CLK may have the logic low level, the logic signal LGS[n] may have the logic high level, the inverted clock signal CLKB may have the logic high level, and the carry signal CR[n] may have the logic high level.

In the third period TP3A, the clock signal CLK may have the logic low level. Since the clock signal CLK may have the logic low level, the first flip-flop FF1 may not sample the previous carry signal CR[n-1]. Accordingly, the logic signal LGS[n] may have the logic high level in the third period TP3A. For example, the logic signal LGS[n] may be maintained at a logic high level in the third period TP3A. In the third period TP3A, the inverted clock signal CLKB may be changed from the logic low level to the logic high level. In the third period TP3A, the second flip-flop FF2 may sample the logic signal LGS[n] based on the rising edge of the inverted clock signal CLKB. In the third period TP3A, the second flip-flop FF2 may sample the logic signal LGS[n] and output the carry signal CR[n] having the logic high level.

In the fourth period TP4A, the previous carry signal CR[n-1] may have the logic low level, the clock signal CLK may have the logic high level, the logic signal LGS[n] may have the logic low level, the inverted clock signal CLKB may have the logic low level, and the carry signal CR[n] may have the logic high level.

In the fourth period TP4A, the clock signal CLK may be changed from the logic low level to the logic high level. In the fourth period TP4A, the first flip-flop FF1 may sample the previous carry signal CR[n-1] based on the rising edge of the clock signal CLK. In the fourth period TP4A, the first flip-flop FF1 may sample the previous carry signal CR[n-1] and output the logic signal LGS[n] having the logic low level. In the fourth period TP4A, the inverted clock signal CLKB may have the logic low level. Accordingly, the carry signal CR[n] may have the logic high level in the fourth period TP4A. For example, the carry signal CR[n] may be maintained at the logic high level in the fourth period TP4A. In the fourth period TP4A, the clock signal CLK may be changed from the logic low level to the logic high level, and the carry signal CR[n] may have the logic high level, so that the next logic signal LGS[n+1] may have the logic high level.

In the fifth period TP5A, the previous carry signal CR[n-1] may have the logic low level, the clock signal CLK may have the logic low level, the logic signal LGS[n] may have the logic low level, the inverted clock signal CLKB may have the logic high level, and the carry signal CR[n] may have the logic low level.

In the fifth period TP5A, the clock signal CLK may have the logic low level. Since the clock signal CLK may have the logic low level, the first flip-flop FF1 may not sample the previous carry signal CR[n-1]. Accordingly, the logic signal LGS[n] may have the logic low level in the fifth period TP5A. For example, the logic signal LGS[n] may be maintained at the logic low level in the fifth period TP5A. In the fifth period TP5A, the inverted clock signal CLKB may be changed from the logic low level to the logic high level. In the fifth period TP5A, the second flip-flop FF2 may sample the logic signal LGS[n] based on the rising edge of the inverted clock signal CLKB. In the third period TP3A, the second flip-flop FF2 may sample the logic signal LGS[n] to output the carry signal CR[n] having the logic low level. In the fifth period TP5A, since the clock signal CLK may have a logic low level, the next logic signal LGS[n+1] may have the logic high level. For example, in the fifth period TP5A, the next logic signal LGS[n+1] may be maintained at the logic high level.

In the sixth period TP6A, the previous carry signal CR[n-1] may have the logic low level, the clock signal CLK may have the logic high level, the logic signal LGS[n] may have the logic low level, the inverted clock signal CLKB may have the logic low level, the carry signal CR[n] may have the logic low level, and the next logic signal LGS[n+1] may have the logic low level.

In the sixth period TP6A, since the carry signal CR[n] may have the logic low level and the clock signal CLK may have the logic high level, the next logic signal LGS[n+1] may have the logic low level.

In an embodiment, as described above, the logic signal LGS[n] may be generated based on the clock signal CLK and the first flip-flop FF1, and the carry signal CR[n] may be generated based on the inverted clock signal CLKB and the second flip-flop FF2. Accordingly, a length of an activation period of the logic signal LGS[n] and the carry signal CR[n] may be longer than a length of one pulse of the clock signal. In an embodiment, for example, the length of a period in which the logic signal LGS[n] and the carry signal CR[n] have a logic high level may be longer than the length of a period in which the clock signal CLK has a logic high level, such that a hold margin of the logic signal LGS[n] and the carry signal CR[n] may be secured. Since the hold margin of the logic signal LGS[n] and the carry signal CR[n] may be secured, a driving reliability of the gate driver 300 may be improved. Accordingly, a display quality of the display device 1 may be improved.

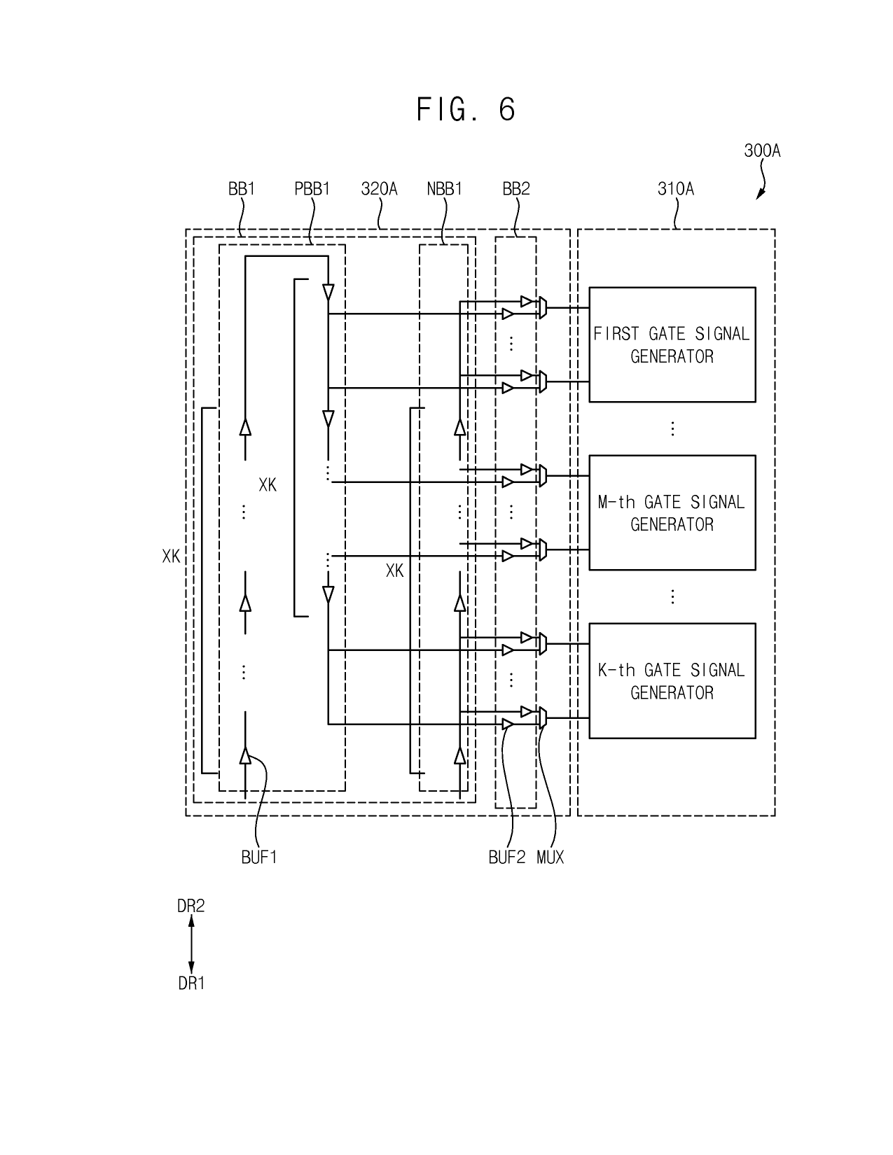

FIG. 6 is a block diagram illustrating an example of a gate driver 300 included in a display device 1 of FIG. 1.

Referring to FIG. 1 to FIG. 6, an embodiment of the gate driver 300A may include a gate signal generating block 310A and a clock signal outputting block 320A. The gate signal generating block 310A may include first to K-th gate signal generators. Each of the first to K-th gate signal generators may include the stage STG. The first to K-th gate signal generators may be sequentially located or arranged in a first direction DR1.

The clock signal outputting block 320A may include a first buffer block BB1, a second buffer block BB2 and a plurality of multiplexers MUX that outputs the clock signal CLK.

The first buffer block BB1 may include a first forward buffer block PBB1 and a first reverse buffer block NBB1. The first buffer block BB1 may include a plurality of first clock buffers BUF1. The first clock buffer BUF1 may include a clock buffer having a structure in which two inverters are connected to each other in series. The first clock buffers BUF1 may be connected to each other in a cascade structure.

The first forward buffer block PBB1 may include the first clock buffers BUF1 located in the second direction DR2 and the first clock buffers BUF1 located in the first direction DR1. In an embodiment, for example, the first forward buffer block PBB1 may include twelve first clock buffers BUF1 located in the second direction DR2. In an embodiment, for example, the first forward buffer block PBB1 may include twelve first clock buffers BUF1 located in the first direction DR1. One first clock buffer BUF1 may be connected to one gate signal generator. One first clock buffer BUF1 may be connected to a plurality of second clock buffers BUF2. One first clock buffer BUF1 may be connected to a plurality of stages STG. In an embodiment, for example, the first-first clock buffer may output a clock signal CLK to the first-second clock buffer and the first gate signal generator. In an embodiment, for example, the first-second clock buffer may output the clock signal CLK to the first-third clock buffer and the second gate signal generator. In an embodiment, for example, the first-M-th clock buffer may output the clock signal CLK to the M-th gate signal generator. Herein, M may be a positive integer less than or equal to K. In an embodiment, for example, the first-K-th clock buffer may output the clock signal CLK to the K-th gate signal generator. Herein, K may be a positive integer less than or equal to N. The first forward buffer block PBB1 may sequentially output the clock signal CLK to the first to K-th gate signal generators.

The first reverse buffer block NBB1 may include the first clock buffers BUF1 located in the second direction DR2. In an embodiment, for example, the first reverse buffer block NBB1 may include twelve first clock buffers BUF1 located in the second direction DR2. In an embodiment, for example, the second-first clock buffer may output the clock signal CLK to the second-second clock buffer and the K-th gate signal generator. In an embodiment, for example, the second-second clock buffer may output the clock signal CLK to the second-third clock buffer and the K-1-th gate signal generator. In an embodiment, for example, the second-M-th clock buffer may output the clock signal CLK to the M-th gate signal generator. In an embodiment, for example, the second-K-th clock buffer may output the clock signal CLK to the first gate signal generator. The first reverse buffer block NBB1 may sequentially output the clock signal CLK to the K-th to first gate signal generator. The number of first clock buffers BUF1 included in the first buffer block BB1 may correspond to the number of gate signal generators included in the gate signal generating block 310A. In an embodiment, for example, where the number of gate signal generators included in the gate signal generating block 310A is K, the first forward buffer block PBB1 may include 2K first clock buffers BUF1, and the first reverse buffer block NBB1 may include K first clock buffers BUF1.

The second buffer block BB2 may include a plurality of second clock buffers BUF2. The second clock buffer BUF2 may include the clock buffer. The second buffer block BB2 may include a second forward buffer block and a second reverse buffer block. The second forward buffer block may be connected to the first forward buffer block PBB1. The second reverse buffer block may be connected to the first reverse buffer block NBB1. The number of second clock buffers BUF2 may correspond to the number of stages STG included in the gate signal generating block 310A. In an embodiment, for example, when the number of stages STG included in the gate signal generating block 310A is N, the number of second clock buffers BUF2 included in the second forward buffer block may be N, and the number of second clock buffers BUF2 included in the second reverse buffer block may be N.

The multiplexers MUX may selectively connect the second forward buffer block or the second reverse buffer block to the stage STG. When the multiplexer MUX connects the second forward buffer block and the stage STG, the clock signal CLK may be sequentially outputted from the first gate signal generator to the K-th gate signal generator. When the multiplexer MUX connects the second reverse buffer block and the stage STG, the clock signal CLK may be sequentially outputted from the K-th gate signal generator to the first gate signal generator.

In an embodiment, a size of the first clock buffer BUF1 may be larger than a size of the second clock buffer BUF2. In an embodiment, for example, the first clock buffer BUF1 may include 16 of the clock buffers, and the second clock buffer BUF2 may include one of the clock buffers. In an embodiment, for example, the first clock buffer BUF1 may include 16 of the clock buffers connected in parallel with each other.

In the present embodiment, the logic signal LGS[n] may be generated based on the clock signal CLK and the first flip-flop FF1, and the carry signal CR[n] may be generated based on the inverted clock signal CLKB and the second flip-flop FF2. Accordingly, a length of an activation period of the logic signal LGS[n] and the carry signal CR[n] may be longer than a length of one pulse of the clock signal. In an embodiment, for example, the length of a period in which the logic signal LGS[n] and the carry signal CR[n] have a logic high level may be longer than the length of a period in which the clock signal CLK has a logic high level, such that a hold margin of the logic signal LGS[n] and the carry signal CR[n] may be secured. Since the hold margin of the logic signal LGS[n] and the carry signal CR[n] may be secured, a driving reliability of the gate driver 300A may be improved. Accordingly, a display quality of the display device 1 may be improved.

Additionally, in such an embodiment, since the hold margin may be secured, the number of clock buffers included in the gate driver 300A may be reduced. Accordingly, an integration of the gate driver 300A may be improved, such that an integration of the display device 1 may be improved. Additionally, a power consumption of the display device 1 may be reduced.

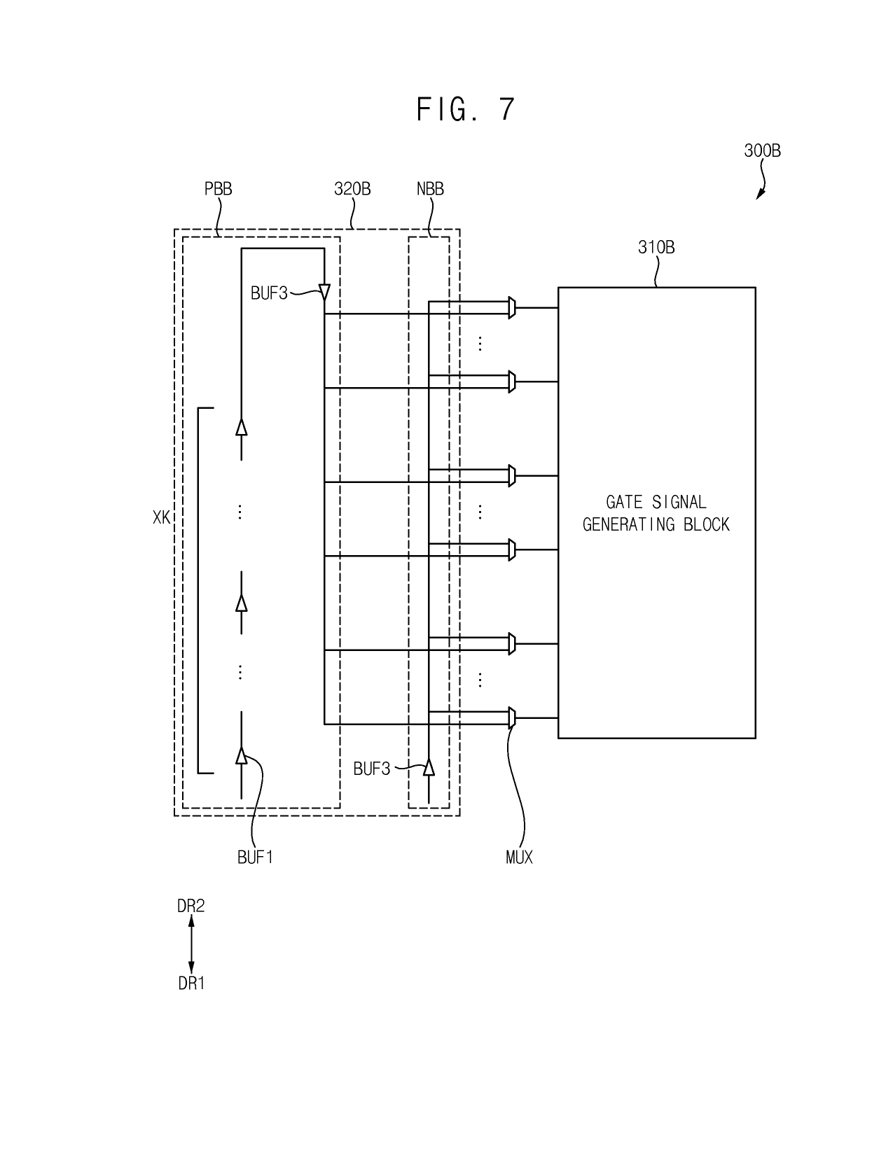

FIG. 7 is a block diagram illustrating an example of a gate driver 300 included in a display device 1 of FIG. 1.

Referring to FIG. 1 to FIG. 5 and FIG. 7, an embodiment of a gate driver 300B may include a gate signal generating block 310B and a clock signal outputting block 320B. The gate signal generating block 310B may include the first to K-th gate signal generators. Each of the first to K-th gate signal generators may include the stage STG. The first to K-th gate signal generators may be sequentially located in the first direction DR1.

The clock signal outputting block 320B may include a buffer block BB that outputs the clock signal CLK and the plurality of the multiplexers MUX.

The buffer block BB may include a forward buffer block PBB and a reverse buffer block NBB. The buffer block BB may include a plurality of first clock buffers BUF1 and a plurality of third clock buffers BUF3. The first clock buffer BUF1 may include a clock buffer having a structure in which two inverters are connected to each other in series. The third clock buffer BUF3 may include a clock buffer having a structure in which two inverters are connected to each other in series. The first clock buffers BUF1 may be connected in a cascade structure.

The forward buffer block PBB may include the first clock buffers BUF1 located in the second direction DR2 and the third clock buffer BUF3 located in the first direction DR1. In an embodiment, for example, the forward buffer block PBB may include twelve first clock buffers BUF1 located in the second direction DR2. In an embodiment, for example, the forward buffer block PBB may include twelve first clock buffers BUF1 located in the first direction DR1. The forward buffer block PBB may include the third clock buffer BUF3 that outputs the clock signal CLK in the second direction DR2. The forward buffer block PBB may output the clock signal CLK in the second direction DR2 to the gate signal generating block 310B.

The reverse buffer block NBB may include the third clock buffer BUF3 located in the second direction DR2. The reverse buffer block NBB may sequentially output the clock signal CLK to the K-th to first gate signal generators.

The multiplexers MUX may selectively connect the forward buffer block PBB or the reverse buffer block NBB to the stage STG. When the multiplexer MUX connects the forward buffer block PBB and the stage STG, the clock signal CLK may be sequentially output from the first gate signal generator to the K-th gate signal generator. When the multiplexer MUX connects the reverse buffer block NBB and the stage STG, the clock signal CLK may be sequentially outputted from the K-th gate signal generator to the first gate signal generator.

In such an embodiment, a size of the third clock buffer BUF3 may be larger than a size of the first clock buffer BUF1. In an embodiment, for example, the third clock buffer BUF3 may include 128 of the clock buffers. In an embodiment, for example, the third clock buffer BUF3 may include 128 of the clock buffers connected in parallel with each other.

In such an embodiment, the logic signal LGS[n] may be generated based on the clock signal CLK and the first flip-flop FF1, and the carry signal CR[n] may be generated based on the inverted clock signal CLKB and the second flip-flop FF2 Accordingly, a length of the activation period of the logic signal LGS[n] and the carry signal CR[n] may be longer than a length of one pulse of the clock signal. In such an embodiment, a length of a period in which the logic signal LGS[n] and the carry signal CR[n] have a logic high level may be longer than a length of a period in which the clock signal CLK has a logic high level, such that a hold margin of the logic signal LGS[n] and the carry signal CR[n] may be secured. Since the hold margin of the logic signal LGS[n] and the carry signal CR[n] may be secured, a driving reliability of the gate driver 300B may be improved. Accordingly, a display quality of the display device 1 may be improved.

Additionally, in such an embodiment, since the hold margin may be secured, the number of clock buffers included in the gate driver 300B may be further reduced. For example, in an embodiment, the gate driver 300B may not include the second buffer block BUF2. Accordingly, an integration of the gate driver 300B may be further improved, such that an integration of the display device 1 may be further improved. Additionally, a power consumption of the display device 1 may be further reduced.

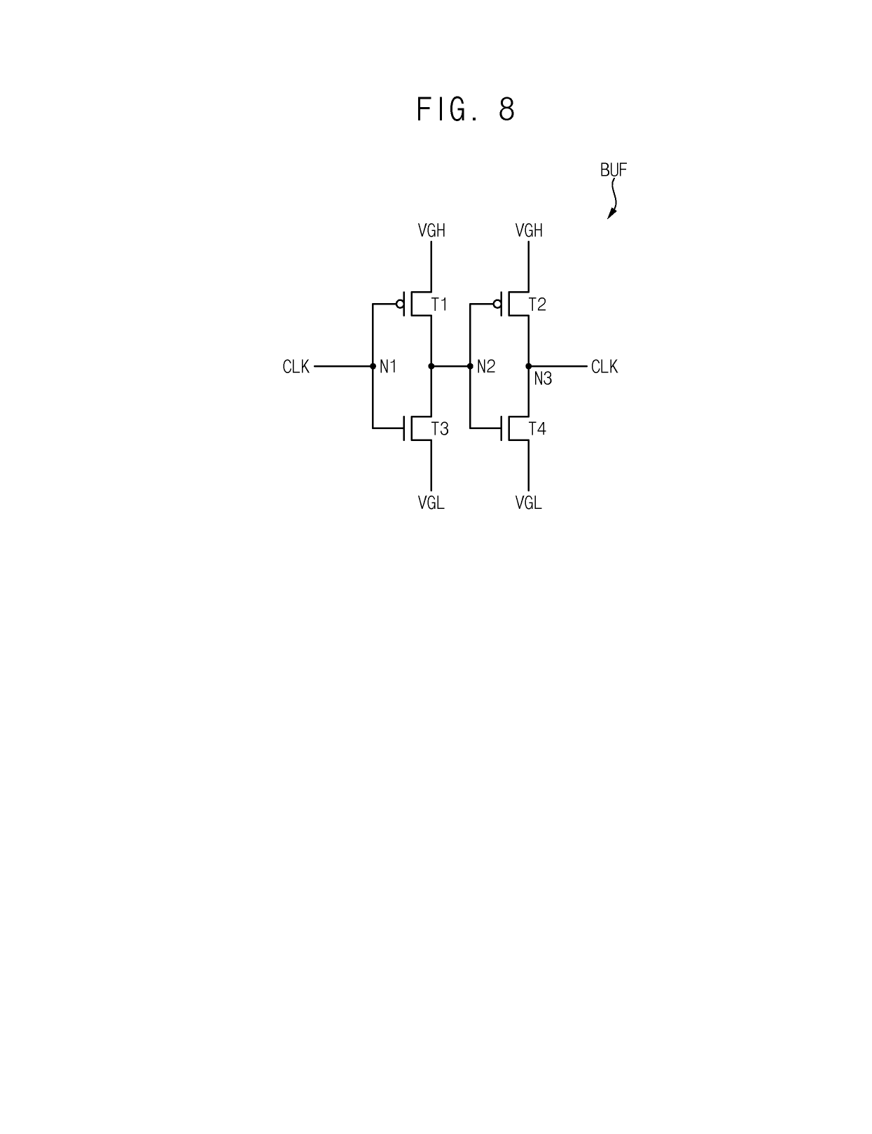

FIG. 8 is a circuit diagram illustrating an example of a clock buffer BUF included in a gate driver 300A of FIG. 6.

Referring to FIG. 1 to FIG. 8, an embodiment of the clock buffer BUF may include first to fourth transistors T1, T2, T3 and T4.

The first transistor T1 may include a control electrode connected to a first node N1, a first electrode that receives a high voltage VGH and a second electrode connected to a second node N2. The clock signal CLK may be applied to the first node N1. The first transistor T1 may be a P-type transistor. The high voltage VGH may correspond to a logic high level of the clock signal CLK.

The second transistor T2 may include a control electrode connected to the second node N2, a first electrode that receives the high voltage VGH and a second electrode connected to a third node N3. The clock signal CLK may be outputted from the third node N3. The second transistor T2 may be a P-type transistor.

The third transistor T3 may include a control electrode connected to the first node N1, a first electrode that receives a low voltage VGL and a second electrode connected to the second node N2. The third transistor T3 may be an N-type transistor. The low voltage VGL may correspond to a logic low level of the clock signal CLK.

The fourth transistor T4 may include a control electrode connected to the second node N2, a first electrode that receives the low voltage VGL and a second electrode connected to the third node N3. The fourth transistor T4 may be an N-type transistor.

The clock buffer BUF may have a structure in which two inverters are connected to each other in series. In an embodiment, for example, the clock buffer BUF may delay and output the clock signal CLK. In an embodiment, for example, the clock buffer BUF may improve a slew rate of the clock signal CLK.

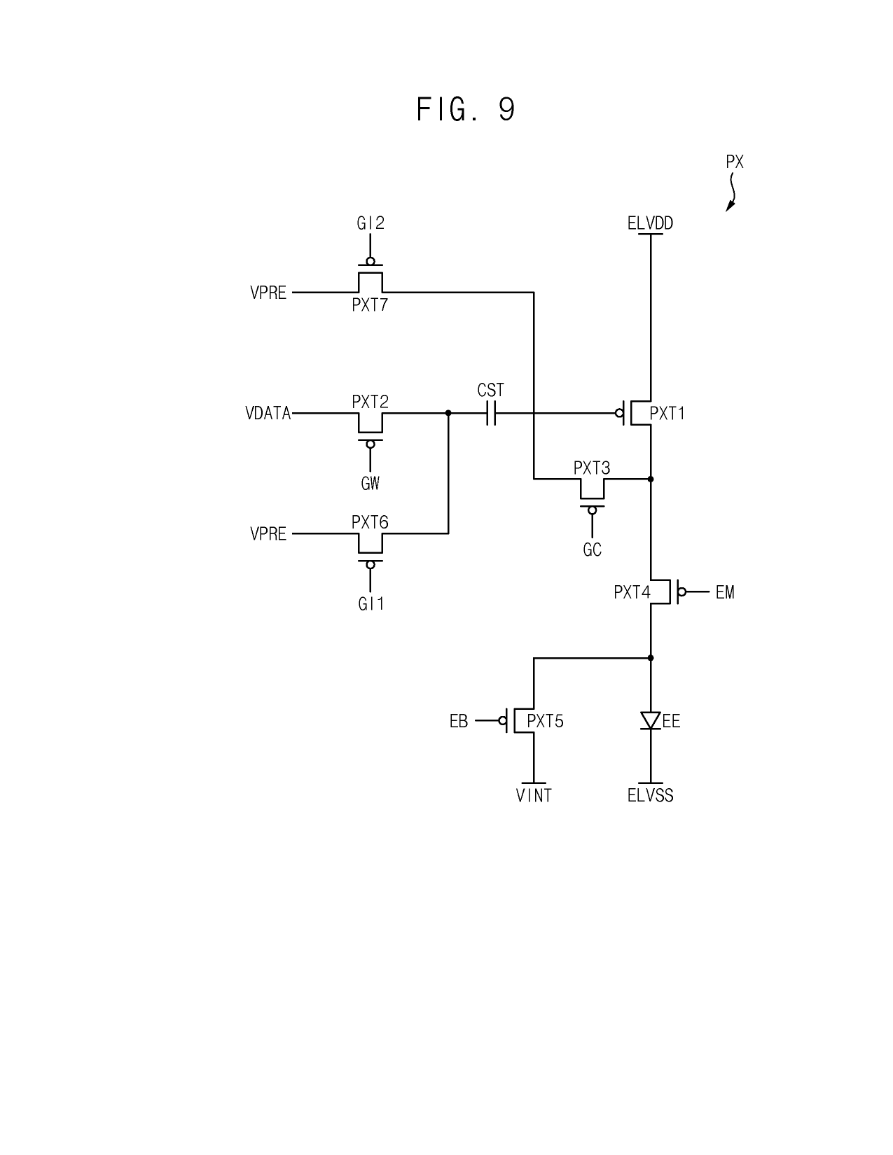

FIG. 9 is a circuit diagram illustrating an example of a pixel PX included in a display device 1 of FIG. 1.

Referring to FIG. 1 to FIG. 9, an embodiment of the pixel PX may include a capacitor CST, a first pixel transistor PXT1, a second pixel transistor PXT2, a third pixel transistor PXT3, a fourth pixel transistor PXT4, a fifth pixel transistor PXT5, a sixth pixel transistor PXT6, a seventh pixel transistor PXT7 and a light-emitting element EE.

The capacitor CST may include a first electrode connected to the second and sixth pixel transistors PXT2 and PXT6 and a second electrode connected to the first, third, and seventh pixel transistors PXT1, PXT3 and PXT7.

The first pixel transistor PXT1 may generate a driving current based on a voltage of the second electrode of the capacitor CST. In an embodiment, the first pixel transistor PXT1 may include a control electrode connected to the second electrode of the capacitor CST, a first electrode that receives a first power voltage ELVDD and a second electrode connected to third and fourth pixel transistors PXT3 and PXT4.

The second pixel transistor PXT2 may apply the data voltage VDATA to the first electrode of the capacitor CST in response to the write gate signal GW. In an embodiment, the second pixel transistor PXT2 may include a control electrode that receives the write gate signal GW, a first electrode that receives the data voltage VDATA and a second electrode connected to the first electrode of the capacitor CST.

The third pixel transistor PXT3 may diode-connect the first pixel transistor PXT1 in response to the compensation gate signal GC. In an embodiment, the third pixel transistor PXT3 may include a control electrode that receives the compensation gate signal GC, a first electrode connected to the second electrode of the first pixel transistor PXT1 and a second electrode connected to the control electrode of the first pixel transistor PXT1.

The fifth pixel transistor PXT5 may apply the initialization voltage VINT to an anode of the light emitting element EE in response to the bias signal EB. In an embodiment, the fifth pixel transistor PXT5 may include a control electrode that receives the bias signal EB, a first electrode that receives the initialization voltage VINT and a second electrode connected to the anode of the light emitting element EE.

The sixth pixel transistor PXT6 may apply a precharge voltage VPRE to the first electrode of the capacitor CST in response to the first initialization gate signal GI1. In an embodiment, the sixth pixel transistor PXT6 may include a control electrode that receives the first initialization gate signal GI1, a first electrode that receives the precharge voltage VPRE and a second electrode connected to the first electrode of the capacitor CST.

The seventh pixel transistor PXT7 may apply the precharge voltage VPRE to the second electrode of the capacitor CST in response to the second initialization gate signal GI2. In an embodiment, the seventh pixel transistor PXT7 may include a control electrode that receives the second initialization gate signal GI2, a first electrode that receives the precharge voltage VPRE and a second electrode connected to the second electrode of the capacitor CST.

The light emitting element EE may emit light based on the driving current generated by the first pixel transistor PXT1. In an embodiment, the light emitting element EE may be, but is not limited to, an organic light emitting diode (OLED). In another embodiment, the light emitting element EE may be a nano light emitting diode (NED), a quantum dot (QD) light emitting diode, a micro light emitting diode, an inorganic light emitting diode, or any other suitable light emitting element. Additionally, in an embodiment, the light emitting element EE may include the anode connected to the second electrode of the fourth pixel transistor PXT4 and a cathode that receives a second power voltage ELVSS.

Although FIG. 9 illustrates an embodiment of the pixel PX having a seven-transistors-one-capacitor (7T1C) structure, the pixel PX of the display device 1 according to embodiments of the invention is not limited to the example of FIG. 9.

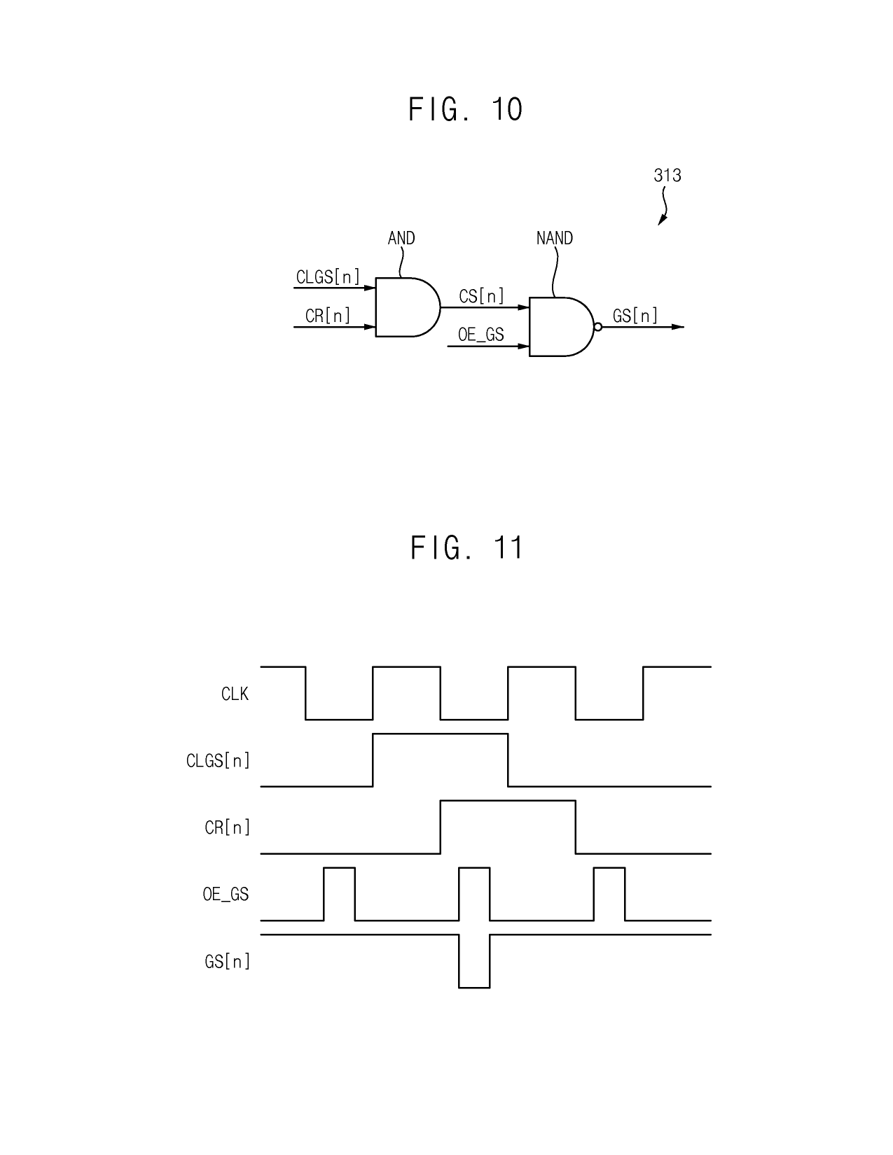

FIG. 10 is a circuit diagram illustrating an example of an outputting block 313 included in a stage STG of FIG. 3. FIG. 11 is a signal timing diagram illustrating an example of signals of an outputting block 313 of FIG. 10.

Referring to FIG. 1 to FIG. 11, an embodiment of the outputting block 313 may include an AND gate AND and a NAND gate NAND.

The AND gate AND may include a first input terminal that receives the converted logic signal CLGS[n], a second input terminal that receives the carry signal CR[n] and an output terminal that outputs a calculation signal CS[n]. The AND gate AND may perform an AND calculation on the converted logic signal CLGS[n] and the carry signal CR[n] to output the calculation signal CS[n].

The NAND gate NAND may include a first input terminal that receives the calculation signal CS[n], a second input terminal that receives a masking signal OE_GS and an output terminal that outputs the gate signal GS[n]. The NAND gate NAND may perform a NAND calculation on the calculation signal CS[n] and the masking signal OE_GS to output the gate signal GS[n]. In an embodiment, the masking signal OE_GS may be outputted from the external device.

In such an embodiment, the logic signal LGS[n] may be generated based on the clock signal CLK and the first flip-flop FF1, and the carry signal CR[n] may be generated based on the inverted clock signal CLKB and the second flip-flop FF2. Accordingly, the length of an activation period of the logic signal LGS[n] and the carry signal CR[n] may be longer than the length of one pulse of the clock signal. In an embodiment, for example, the length of a period in which the logic signal LGS[n] and the carry signal CR[n] have a logic high level may be longer than the length of a period in which the clock signal CLK has a logic high level, such that a hold margin of the logic signal LGS[n] and the carry signal CR[n] may be secured. Since the hold margin of the logic signal LGS[n] and the carry signal CR[n] may be secured, a driving reliability of the gate driver 300 may be improved. Accordingly, a display quality of the display device 1 may be improved.

Additionally, in such an embodiment, the gate signal GS[n] may be outputted based on the calculation signal CS[n] and the masking signal OE_GS. Accordingly, a power consumption of the display device 1 may be improved. Additionally, since the calculation signal CS[n] may be outputted by performing an AND calculation on the carry signal CR[n] and the converted logic signal LGS[n], an output reliability of the gate signal GS[n] may be further improved.

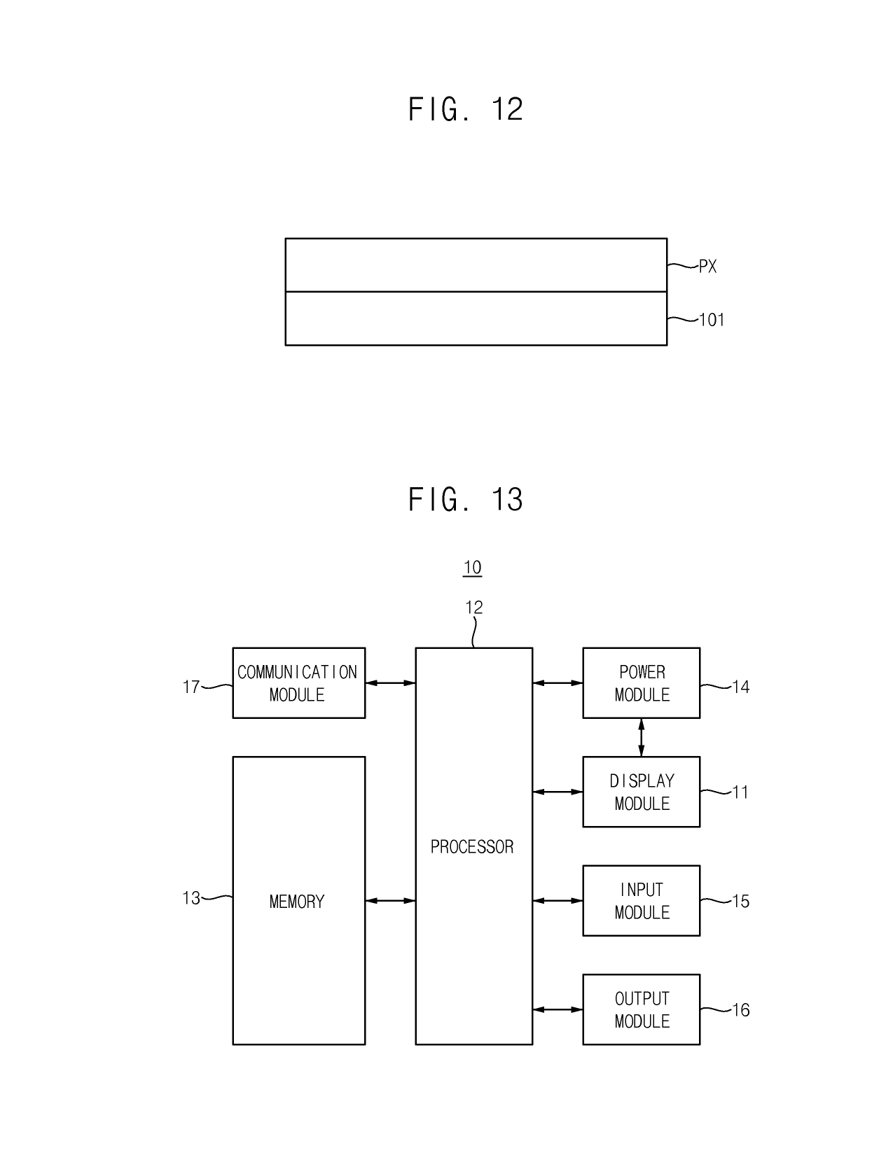

FIG. 12 is a diagram illustrating an example of a pixel circuit PX included in a display device 1 of FIG. 1 is located on a substrate 101.

Referring to FIG. 1 and FIG. 12, the pixel circuit PX may be located (or disposed) on a substrate 101. In an embodiment, the substrate 101 may be a silicon-based substrate. In an embodiment, the pixel circuit PX may be located on a silicon-based substrate.

The silicon-based substrate may include a single-crystal silicon wafer, a polycrystalline silicon wafer, or an amorphous silicon wafer. A semiconductor layer may be formed on the silicon-based substrate through a semiconductor process. In an embodiment, for example, the silicon substrate on which the semiconductor layer is formed may be a silicon semiconductor substrate.

In an embodiment, the semiconductor layer may be formed on the silicon-based substrate through a complementary metal oxide semiconductor (CMOS) process. The semiconductor layer may include a pixel circuit in the form of a CMOS. In an embodiment, for example, the pixel circuit PX may include a CMOS circuit including a P-type transistor and an N-type transistor. Accordingly, the display device 1 may be a display-on-silicon (DOS, e.g., (light emitting diode on silicon (LEDoS)) having a light emitting structure on a silicon semiconductor substrate.

Since the pixel PX may be located on a silicon-based substrate, the voltage levels of input signals applied to the pixel PX may be set more precisely. Additionally, since the pixel PX may be located on a silicon-based substrate, at least one of the transistors included in the pixel PX may be a metal oxide semiconductor (MOS) transistor. Accordingly, a driving stability of the at least one transistor may be improved. Accordingly, the driving stability and emission reliability of the pixel PX may be improved.

FIG. 13 is a block diagram illustrating an electronic device 10 according to embodiments of the invention.

Referring to FIG. 13, an electronic device 10 according to an embodiment may include a display module 11, a processor 12, a memory 13 and a power module 14.

The processor 12 may include at least one selected from a central processing unit (CPU), an application processor (AP), a graphic processing unit (GPU), a communication processor (CP), an image signal processor (ISP), and a controller.

The memory 13 may store data information for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power for the operation of the electronic device 10.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the individual modules functionally included in one module may be included in the display device, and others thereof may be provided separately from the display device. In an embodiment, for example, the display device may include the display module 11, and the processor 12, the memory 13, and the power module 14 may be provided in the form of other devices within the electronic device 10 other than the display device.

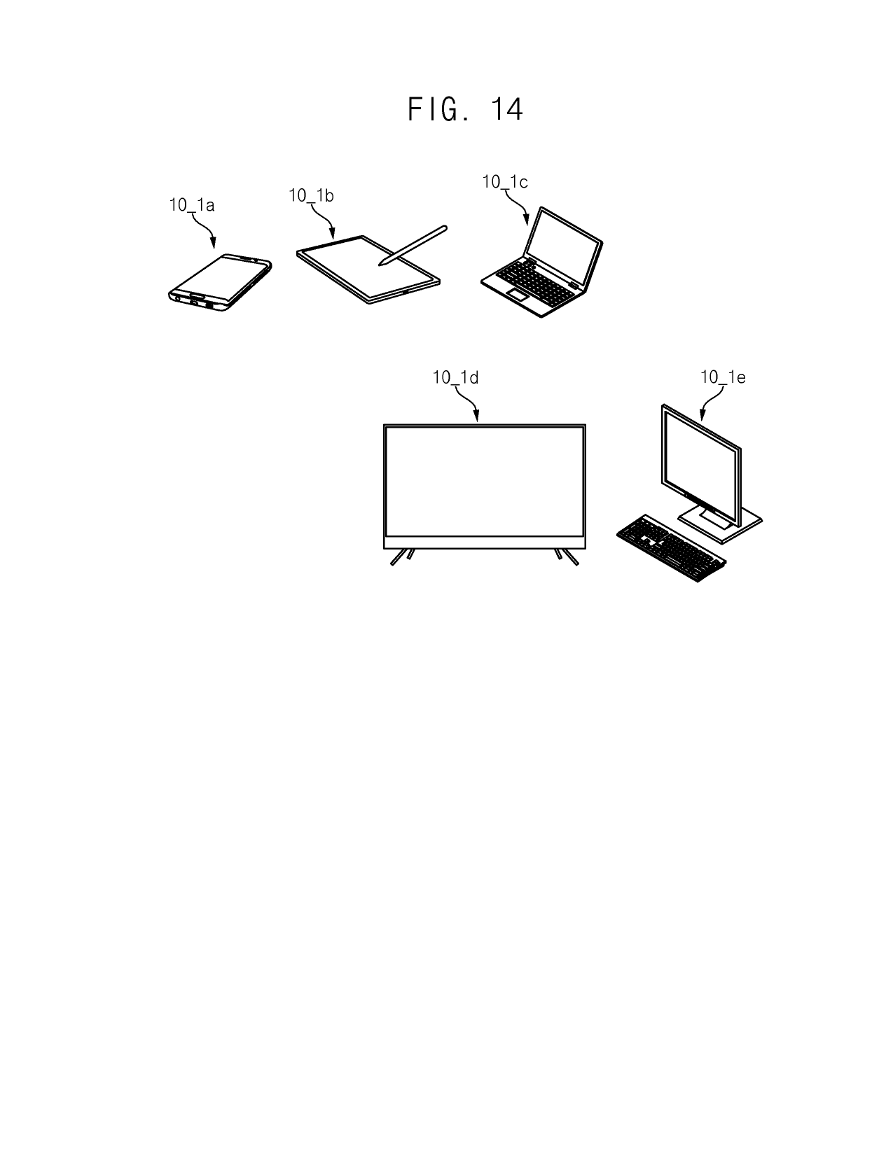

FIG. 14 to FIG. 16 are schematic diagrams illustrating an electronic device according to embodiments.

Referring to FIG. 14, a smartphone 10_1a, a tablet personal computer (PC) 10_1b, a laptop computer 10_1c, a television (TV) 10_1d, and a desk monitor 10_1e are examples of electronic devices.

The smartphone 10_1a may include an input module such as a touch sensor and a communication module in addition to the display module 11. The smartphone 10_1a may process information received through the communication module or other input modules and display the information through the display module of the display device.

In the case of tablet PC 10_1b, laptop computer 10_1c, TV 10_1d, and desk monitor 10_1e, may include a display module and an input module similar to the smartphone 10_1a, and in some cases, may further include a communication module.

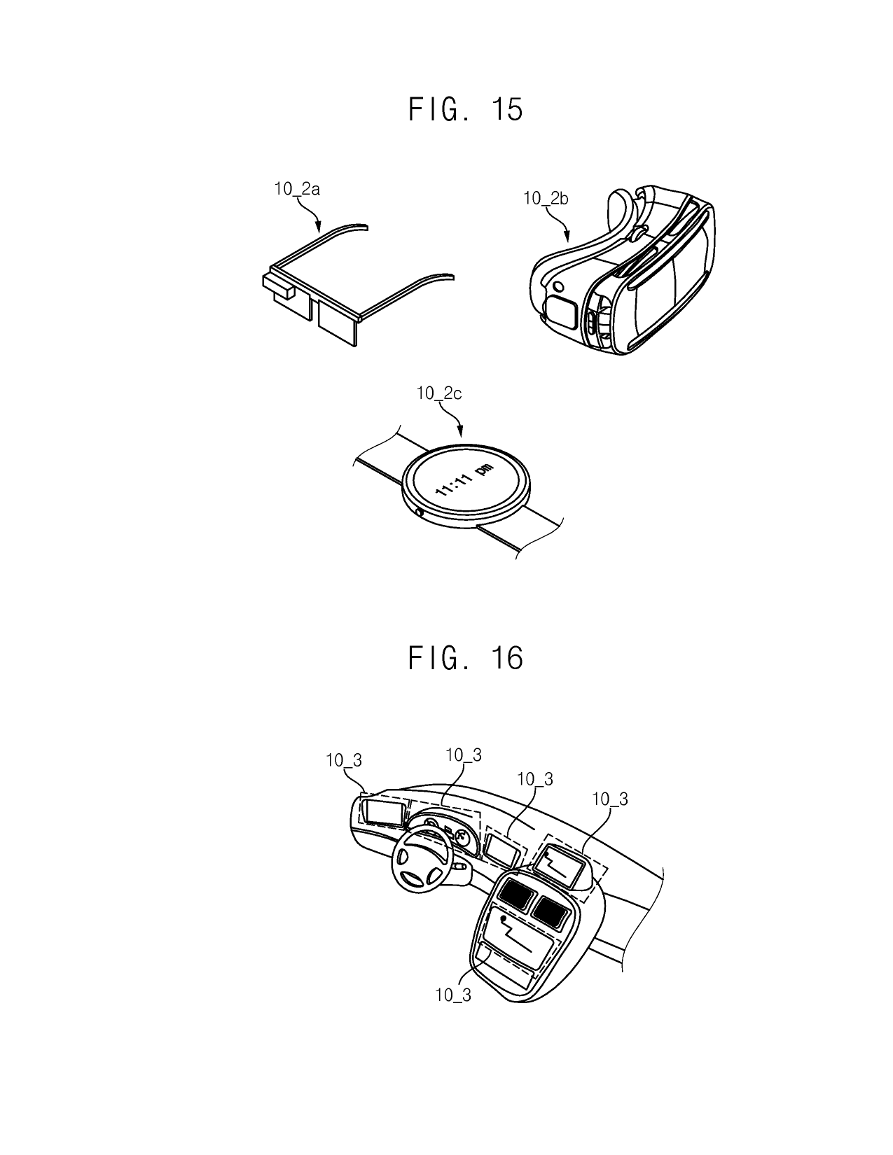

Referring to FIG. 15, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user's eyes, thereby providing a virtual reality or augmented reality screen to the user.

The smartwatch 10_2c may include a biometric sensor as an input device and may provide biometric information recognized by the biometric sensor to the user through a display module.

Referring to FIG. 16, in an embodiment, an electronic device including a display module may be applied to a vehicle. For example, the electronic device 10_3 may be applied to a dashboard, center fascia, etc. of a vehicle, or may be applied to a center information display (CID) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including a pixel;
a gate driver which outputs a gate signal to the display panel;
a data driver which applies a data voltage to the display panel; and
a driving controller which controls the gate driver and the data driver,
wherein the gate driver includes a plurality of gate signal generators,
wherein a gate signal generator of the gate signal generators includes:
a first flip-flop which receives a clock signal and outputs a logic signal by sampling a previous carry signal at a rising edge of the clock signal;
a first invertor which receives the clock signal and outputs an inverted clock signal having inverted waveform of the clock signal; and
a second flip-flop which outputs a carry signal by sampling the logic signal at a rising edge of the inverted clock signal, and
wherein the gate driver outputs the gate signal based on the logic signal.

2. The display device of claim 1, wherein a period in which the gate driver is driven includes first to sixth periods, and
wherein in the first period, the previous carry signal has a logic high level, the clock signal has a logic low level, the inverted clock signal has a logic high level, the carry signal has a logic low level, and the logic signal has a logic low level.

3. The display device of claim 2, wherein in the second period following the first period, the previous carry signal has the logic high level, the clock signal has a logic high level, the inverted clock signal has a logic low level, the carry signal has the logic low level, and the logic signal has a logic high level.

4. The display device of claim 3, wherein in the third period following the second period, the previous carry signal has a logic low level, the clock signal has the logic low level, the inverted clock signal has the high low level, the carry signal has a logic high level, and the logic signal has the logic high level.

5. The display device of claim 4, wherein in the fourth period following the third period, the previous carry signal has the logic low level, the clock signal has the logic high level, the inverted clock signal has the logic low level, the carry signal has the logic high level, and the logic signal has the logic low level.

6. The display device of claim 5, wherein in the fifth period following the fourth period, the previous carry signal has the logic low level, the clock signal has the logic low level, the inverted clock signal has the logic high level, the carry signal has the logic low level, and the logic signal has the logic low level.

7. The display device of claim 6, wherein in the sixth period following the fifth period, the previous carry signal has the logic low level, the clock signal has the logic high level, the inverted clock signal has the logic low level, the carry signal has the logic low level, and the logic signal has the logic low level.

8. The display device of claim 1, wherein the first flip-flop includes an input terminal which receives the previous carry signal, clock terminal which receives the clock signal and an output terminal which outputs the logic signal,
wherein the first invertor includes an input terminal which receives the clock signal and an output terminal which outputs the inverted clock signal, and
wherein the second flip-flop includes an input terminal which receives the logic signal, a clock terminal which receives the inverted clock signal and an output terminal which outputs the carry signal.

9. The display device of claim 1, wherein the gate signal generator further includes,
a level shifting block which outputs a first logic signal by changing a voltage level of the logic signal; and
an outputting block which outputs the gate signal based on the first logic signal.

10. The display device of claim 9, wherein the outputting block includes:
an AND gate which outputs a second logic signal by performing an AND calculation between the first logic signal and the carry signal; and
a NAND gate which outputs the gate signal by performing a NAND calculation between the second logic signal and a masking signal.

11. The display device of claim 1, wherein the gate driver includes:
first to K-th gate signal generators which are sequentially arranged in a first direction, wherein K is an integer greater than 1; and
a clock signal outputting block which outputs the clock signal,
wherein the clock signal outputting block includes:
a first buffer block which outputs the clock signal; and
a second buffer block which outputs the clock signal to each of the first to K-th gate signal generators, and
wherein the first buffer block has a cascade structure of a plurality of first clock buffers.

12. The display device of claim 11, wherein the first buffer block includes:
a first buffer group in which the first clock buffers are sequentially arranged in the first direction; and
a second buffer group in which the first clock buffers are sequentially arranged in a second direction opposite to the first direction, and
wherein the second buffer block includes multiplexers which selectively connect a corresponding one of the first buffer group and the second buffer group to each of the first to K-th gate signal generator.

13. The display device of claim 12, wherein the second buffer block further includes second clock buffers connected between the first buffer block and the multiplexer, and
wherein a size of the first clock buffer is larger than a size of the second clock buffer.

14. The display device of claim 13, wherein the first clock buffer includes sixteen clock buffers, and the second clock buffer includes one clock buffer, and
wherein the clock buffer has a structure in which two invertors are connected to each other in series.

15. The display device of claim 11, wherein the clock buffer includes:
a first transistor including a control electrode connected to a first node, a first electrode which receives a high voltage and a second electrode connected to a second node;
a second transistor including a control electrode connected to the second node, a first electrode which receives the high voltage and a second electrode connected to a third node;
a third transistor including a control electrode connected to the first node, a first electrode which receives a low voltage lower than the high voltage and a second electrode connected to the second node; and
a fourth transistor including a control electrode connected to the second node, a first electrode which receives the low voltage and a second electrode connected to the third node.

16. An electronic device comprising:
a display panel including a pixel;
a gate driver which outputs a gate signal to the display panel;
a data driver which applies a data voltage to the display panel;
a driving controller which controls the gate driver and the data driver based on an input control signal; and
a processor which outputs the input control signal,
wherein the gate driver includes a plurality of gate signal generators,
wherein a gate signal generator of the gate signal generators includes:
a first flip-flop which receives a clock signal and outputs a logic signal by sampling a previous carry signal at a rising edge of the clock signal;
a first invertor which receives the clock signal and outputs an inverted clock signal having inverted waveform of the clock signal;
a second flip-flop which outputs a carry signal by sampling the logic signal at a rising edge of the inverted clock signal, and
wherein the gate driver outputs the gate signal based on the logic signal.

17. The electronic device of claim 16, wherein the first flip-flop includes an input terminal which receives the previous carry signal, clock terminal which receives the clock signal and an output terminal which outputs the logic signal,
wherein the first invertor includes an input terminal which receives the clock signal and an output terminal which outputs the inverted clock signal, and
wherein the second flip-flop includes an input terminal which receives the logic signal, a clock terminal which receives the inverted clock signal and an output terminal which outputs the carry signal.

18. The electronic device of claim 16, wherein the gate signal generator further includes,
a level shifting block which outputs a first logic signal by changing a voltage level of the logic signal; and
an outputting block which outputs the gate signal based on the first logic signal.

19. The electronic device of claim 18, wherein the outputting block includes:
an AND gate which outputs a second logic signal by performing an AND calculation between the first logic signal and the carry signal; and
a NAND gate which outputs the gate signal by performing a NAND calculation between the second logic signal and a masking signal.

20. The electronic device of claim 16, wherein the gate driver includes:
first to K-th gate signal generators which are sequentially arranged in a first direction, wherein K is an integer greater than 1; and
a clock signal outputting block which outputs the clock signal,
wherein the clock signal outputting block includes:
a first buffer block which outputs the clock signal; and
a second buffer block which outputs the clock signal to each of the first to K-th gate signal generators, and
wherein the first buffer block has a cascade structure of a plurality of first clock buffers.
